(19) United States
(12) Patent Application Publication
(10) Pub. No.: US 2005/0252402 A1
(43) Pub. Date: Nov. 17, 2005

(54) Method for operating a developing machine and developing machine

(76) Inventors: Jürgen Mackel, Oelde (DE); Ralf Kleinhaus, Gutersloh (DE); Martin Fuhrmann, Vilsheim (DE); Helmut Knoblechner, Munchen (DE); Wolfgang Rauh, Munchen (DE); Stephan Dietzel, Halle (DE); Alexander Schiller, Munchen (DE); Ulrich Schmitt, Hohenpolding (DE)

Correspondence Address: GAUTHIER & CONNORS, LLP, 225 FRANKLIN STREET, BOSTON, MA, 02110, US

(21) Appl. No.: 11/156,157

(22) Filed: Jun. 17, 2005

Related U.S. Application Data
(63) Continuation of application No. PCT/EP03/13738, filed on Dec. 5, 2003.

(30) Foreign Application Priority Data
Dec. 16, 2002 (DE) 10259025.7

(51) Int. Cl. G03G 9/00

(52) U.S. Cl. 101/483

(57) ABSTRACT

This invention relates to a method for operating a developing machine for producing printing plates, in particular offset printing plates, preferably in a CTP process. According to said method, contaminated liquid developer is fed to a separator to be treated. At least some of the contaminants are separated from the liquid developer in the centrifugal field of said separator. The developing machine comprises a container, which holds the liquid developer and is connected to the separator.

### PRIORITY INFORMATION

This application is a continuation of International Patent Application PCT/EP2003/13738, filed on Dec. 5, 2003, which claims priority to German Patent Application DE10259025.7, filed on Dec. 16, 2002 both of which are included herein by reference in their entirety.

### BACKGROUND OF THE INVENTION

1. Field of Invention

The invention relates to a method for operating a developing machine wherein offset printing plates are made with the use of a liquid developer. The contaminated liquid developer is conveyed for conditioning to a centrifuge fashioned as a non-self-discharging chamber separator with disk insert in whose centrifugal field at least a portion of the contaminants is separated from the liquid developer. The liquid developer is withdrawn in bypass fashion from a vessel and conveyed back into the vessel after passage through the separator. Additionally, the invention relates to a developing machine characterized in that the separator is provided with replaceable solids collecting containers, in particular plastic containers.

2. Description of Prior Art

Prior art of the stated kind is known from DE 8406851. Further such prior art is exhibited by DE 35 34 099.

### SUMMARY OF THE INVENTION

A precoated positive offset printing plate comprises an aluminum plate oxidized in a fashion well-defined as to area, to which a light-sensitive polymer coating 2/m to 5 μm thick is applied. Between these layers there is a seal layer that takes care of, among other things, complete photoduplication of the exposed polymers. The polymers as a rule are novolaks (phenol-formaldehyde copolymers) partly esterified with sulfonated naphthoquinonediazides. The naphthoquinonediazides are converted by irradiation with UV radiation to indenecarboxylic acids that are soluble in alkali. The presence of water is necessary to the photoreaction.

With regard to chemical composition, “printing plate” liquid developers differ fundamentally from the film developers and photo-paper developers known from photography. In distinction to photographic developers, they do not transform a latent image to a visible image but merely remove the polymers of the printing plate that are soluble after exposure. The developer solutions in general are made up of aqueous, strongly alkaline sodium metasilicate solutions with a content of phosphates and wetting agents.

As it is used, the developer becomes enriched in dissolved indenecarboxylic acids and reacts with atmospheric carbon dioxide.

Liquid developers for negative printing plates can vary very widely in chemical composition. The reason lies in differences in the constituents of the copying layer from one printing plate manufacturer to another and in the optimization of developer solutions for precisely these printing plates. All these developer solutions have in common that they become enriched in particles as they are used. Despite the commonly practiced regeneration, these solutions are limited in life. An important reason is enrichment in solid particles. In the industry, this effect is referred to as “sludge buildup.”

The manufacturers of printing plates and printing plate developers recommend the use of so-called regenerates in order to extend the life of this solution.

Despite the use of these regenerates, large quantities of spent liquid developers are created in operation. Their disposal is relatively costly, because liquid developers frequently contain a non-negligible content of water-soluble organic solvents and must not be drained into the sewers.

In view of this expense, it is desirable to condition or purify the spent liquid developer from plate development in offset printing.

It is known to employ filtration systems to purify spent liquid developer. A satisfactory purifying action is also achieved in this way. The relatively high cleaning and maintenance requirement of the filtration systems is, however, disadvantageous, in particular because of the small capacity of the filtration systems. Cross-flow filtration systems might be of help here.

Their procurement costs, however, are too high for the planned intended purpose. It is also a problem that the filtration systems must in each case be relatively exactly adapted to the liquid developer in use in each case; that is, with one filtration system it is not possible to implement a conditioning device that can be employed in any kind of “universal” manner with a wide variety of offset plate liquid developers.

It is a goal of the invention to solve this problem. The developing machine is to be operated in such a fashion that its operation is rendered simpler and less expensive.

The invention achieves this object through offset printing plates which are made with the use of a liquid developer. The contaminated liquid developer is conveyed for conditioning to a centrifuge fashioned as a non-self-discharging chamber separator with disk insert in whose centrifugal field at least a portion of the contaminants is separated from the liquid developer. The liquid developer is withdrawn in bypass fashion from a vessel and conveyed back into the vessel after passage through the separator with respect to the method and through the separator which is provided with replaceable solids collecting containers, in particular plastic containers with respect to the machine.

According thereto, contaminated liquid developer for conditioning is fed to a centrifuge, in particular a separator, in whose centrifugal field at least a portion of the contaminants is separated from the liquid developer. The centrifuge is preferably designed such that its acceleration value (G number) acting on the product at the outside diameter of the plate is larger than 5000.

With the aid of the separator, the liquid developer can be conditioned to the extent that it can be reused. This markedly lowers the costs of purchasing liquid developer in comparison with a solution with no conditioning.

The costs of disposal are also reduced because the quantities for disposal become smaller. Also connected herewith are lesser efforts for replacing the liquid, which is an unpleasant and laborious job because the liquid to be disposed of can be hazardous to the health.

Obviously, the relatively fine “dirt particles” relatively quickly load a filter, which would have to have a correspondingly fine pore size. This would make excessive demands even on relatively expensive filters that operate in cross-flow. The installation of a filter would therefore be possible only in combination with a specially matched developer. This problem does not, on the other hand, arise when a separator is employed.

In contrast to the case with a conditioning device having a filtration system, liquid developers of the most varied kinds can be processed by the especially easily adjustable and operable separator without any need to modify the design of the separator. All that may be necessary is to adapt the settings of the separator to the changed liquid. Maintenance of the separator is simple and inexpensive. Moreover, it is often possible to employ a very compact piece of equipment, so that the entire conditioning device can be situated in a very small space.

An assessment of the economics of the method has shown that with a typical developing machine, savings of up to several thousand euro per year can be attained by employing the invention, because the yearly consumption of liquid developer is reduced significantly (by approximately two-thirds) and also because the apparatus requires substantially fewer cleanings. This saving makes it possible to amortize the costs of the system within a few years.

According to a variant, the separator is provided with replaceable solids collecting containers, in particular plastic containers, simplifying the disposal of the separated-out solids or contaminants.

### BRIEF DESCRIPTION OF THE DRAWINGS

In what follows, the invention is explained in greater detail on the basis of exemplary embodiments with reference to the drawings, in which:

FIG. 1 is a schematic depiction of a developing machine;

FIG. 2 is a flowchart;

FIG. 3 is a sectional depiction of a separator that can be employed in the method of FIG. 1;

FIG. 4 is a diagram illustrating the action of a filter in the conditioning of the liquid developer;

FIG. 5 is a diagram illustrating the action of a separator in the conditioning of the liquid developer;

FIG. 6 is a further diagram illustrating the action of a separator in the conditioning of the liquid developer based on the determination of the signal intensity of the copier layer constituents;

FIG. 7 is a diagram illustrating the action of a separator in the conditioning of the liquid developer based on the determination of the conductivity of the liquid developer.

### DETAILED DESCRIPTION OF THE INVENTION

Developing machine 20 with machine frame 21—with regard to the possible structure, see for example the detailed discussions in the prior art cited at the beginning of the specification—has a device for the conditioning of liquid developer that is used, for example, in the making of printing plates by the CTP (computer to plate) method.

The developing machine comprises a vessel 1 with liquid developer from which the liquid developer is conveyed in bypass fashion here by a product pump 4 via a line 2 to rough purification and pre-purification via a prescreen 3 (e.g., 300 to 400 μm) to the inlet 5 of a separator 6. In the centrifugal field of separator 6, which is here disposed directly beneath vessel 1, contaminants, in particular solids 7, are separated from the remaining liquid developer, which is led back into tank 1 via a line 8. The sole function of prescreen 3 is to keep coarse parts from the disk stack of the separator.

Through the selected arrangement, a liquid flow is generated and sustained for the liquid developer in the vessel by the arrangement of inlet (line 2 downward) and outlet (line 8 from the side), with advantageous effects in operation.

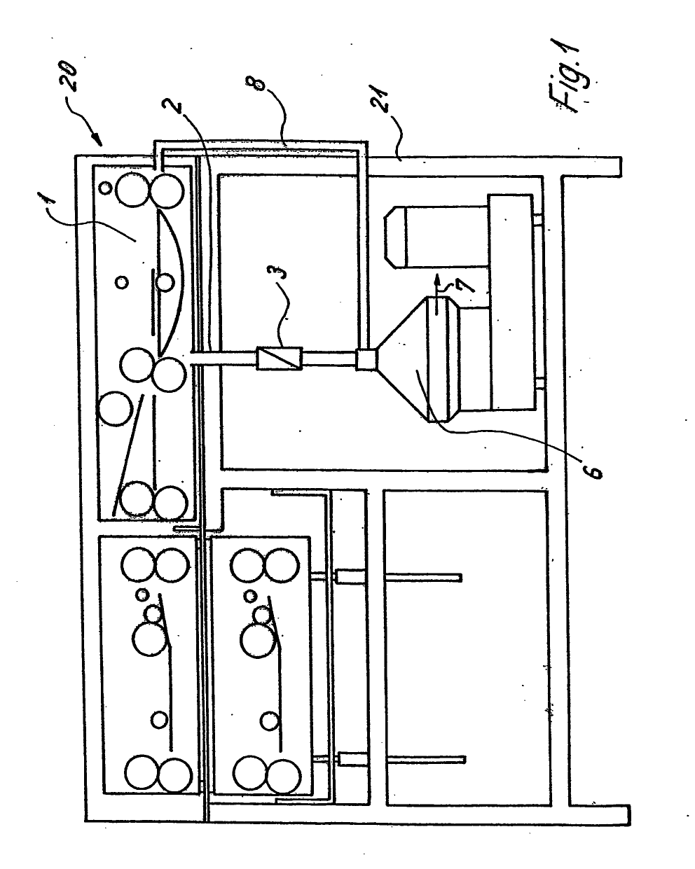

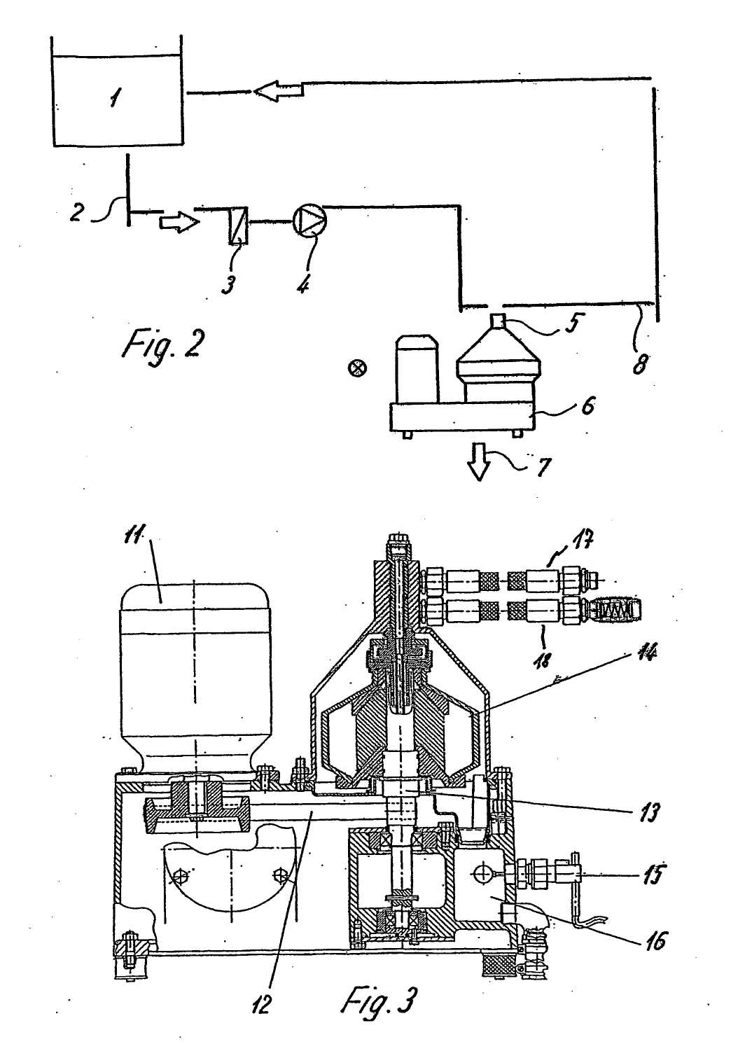

Separators particularly suitable for employment in the method of FIG. 1 are available under the designations OTC2, OSD2 and OTC3 from Westfalia Mineraloil Systems GmbH, Oelde, Germany. The compact chamber separators with disk insert of this type each have a direct drive with a standard motor 11 and a flat belt 12. Drive spindle 13 and the distributor are fashioned as a combined component. In FIG. 3, inlet 17 and outlet 18 with check valve can be seen at top right on the separator, one directly under the other.

The solid material being separated is manually removed from the drum at intervals (for example after several months, depending on the mode of operation) with the aid of a plastic insert in drum compartment 14. The low-noise separators of the stated type have a monitoring device (overflow protection) integrated into the machine frame and comprising float switch 15 and overflow measuring chamber 16 integrated into the frame. Uncontrolled overflowing of the separator is promptly reported to the operator by this monitoring device.

Particularly suitable for purifying liquid developer is applicant's OTC 2-02-137 separator, which has a solid-shell disk chamber.

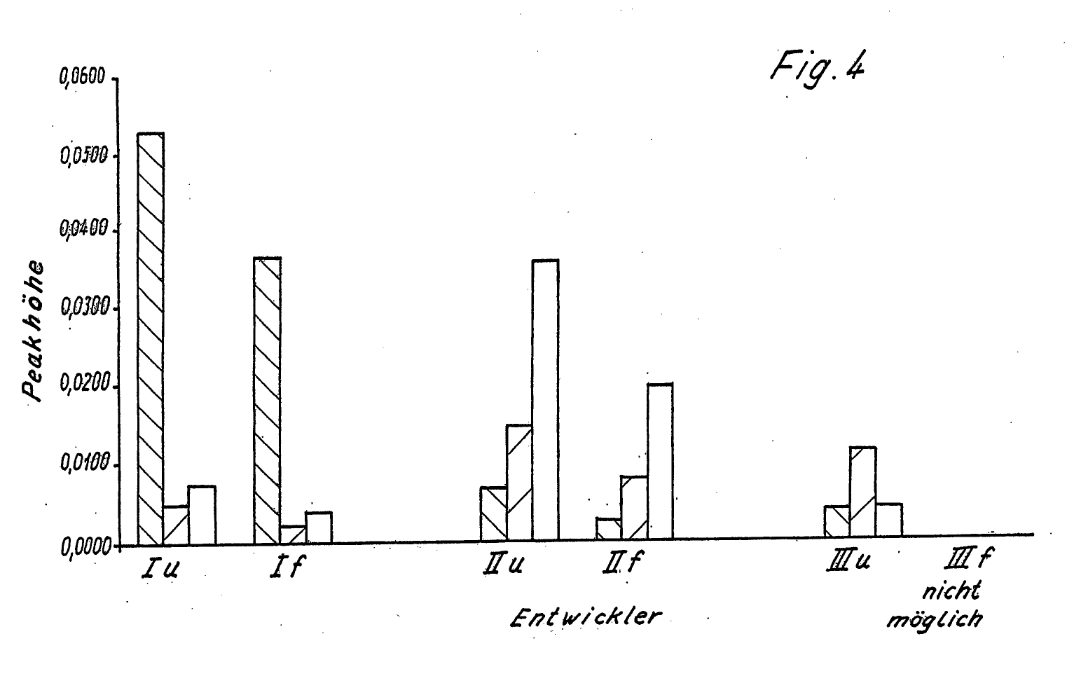

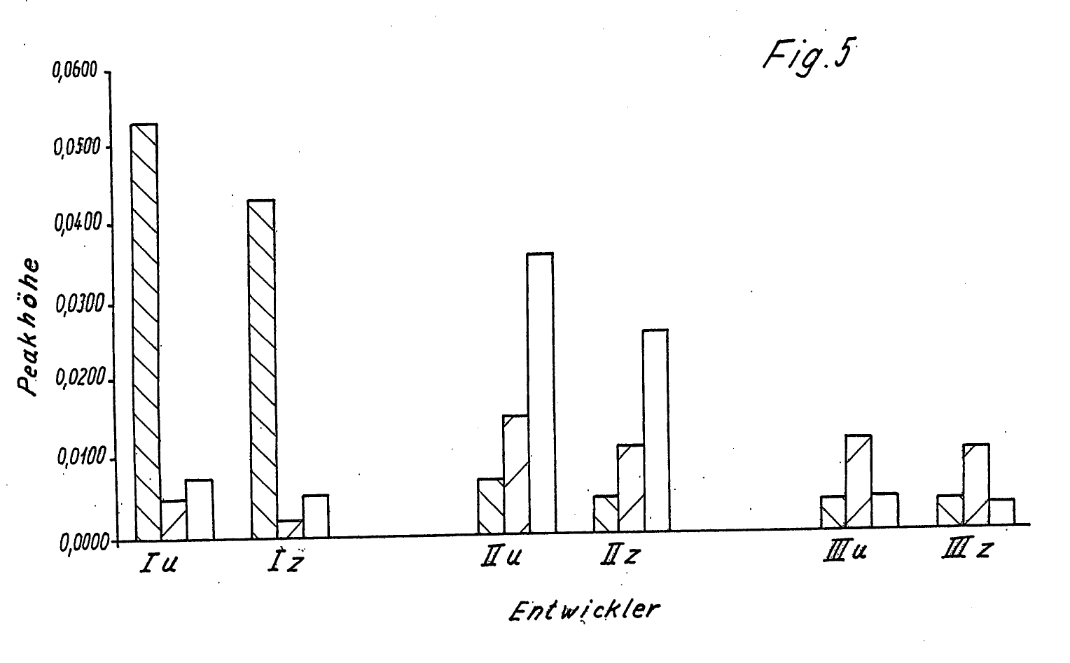

A comparison of FIG. 4 (filtration: u, measurement without filtration; f, with filtration) and FIG. 5 (separator: u, measurement without centrifuge; z, with centrifuge) shows that employment of a filter with a pore opening of 45 μm initially gives a particle depletion comparable to that of a separator for two developers I, II (determination by chemical analysis with liquid-phase chromatography).

On the other hand, one liquid developer (III) could not be conditioned at all with the selected filter. A possible explanation is a surface tension effect. This problem, surprisingly, does not arise when centrifuges are employed.

Because, furthermore, the particles being removed by filtration leads to an extremely rapid plugging of the filter employed, the diagram of FIG. 4 becomes degraded in practice after only a few cleaning operations, so that employment of the filter is also not expedient in economic terms.

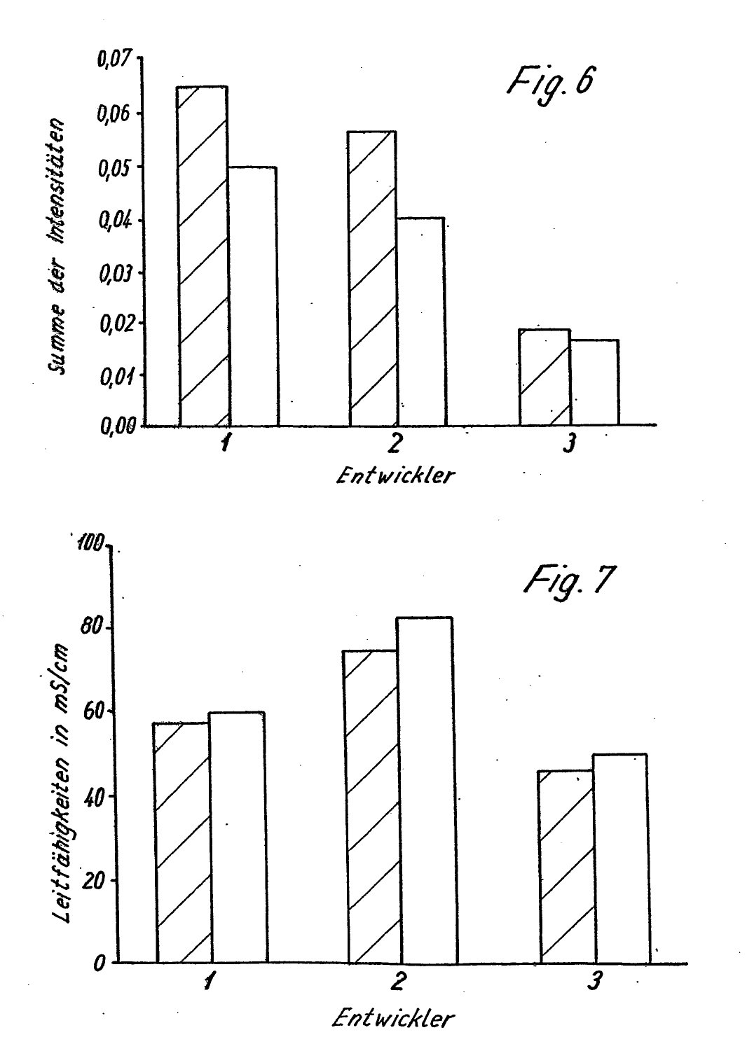

FIG. 6 illustrates the change in signal intensity of the copier layer constituents in a chromatogram of spent developer solutions (1, 2, 3) before centrifugation (hatched) and after centrifugation (unhatched). The chromatograms show that after a centrifugation it is possible to detect in the chromatogram a depletion in substances or contaminants identified as constituents of the copier layers.

The conductivity is also changed in parallel fashion by centrifugation (see FIG. 7). For all liquid developers it rises again but does not reach the starting value again. This is also unanticipated because, as the chromatograms show, the content of copier layer constituents decreases by only 15 to 20% as a result of a single centrifugation.

For this reason it is recommended that the centrifuge be left running continuously while the developing machine is in operation and that liquid developer be continuously withdrawn from vessel 1 or the bath, conditioned, and conveyed back into the bath. Alternatively, suitably designed intermittent operation is also conceivable.

1. A method for operating a developing machine wherein printing plates, in particular offset printing plates, are made with the use of a liquid developer, wherein contaminated liquid developer is conveyed for conditioning to a centrifuge, in particular a separator, in whose centrifugal field at least a portion of the contaminants is separated from the liquid developer.

2. Method according to claim 1, wherein the liquid developer is withdrawn in bypass fashion from a vessel and conveyed back into the vessel after passage through the separator.

3. Method according to claim 1, wherein the liquid developer is conveyed to the separator via a prescreen.

4. Method according to claim 1, wherein the separation of the contaminants takes place continuously during operation.

5. Method according to claim 1, wherein the separation of the contaminants is effected using a non-self-discharging chamber separator with disk insert.

6. Method according to claim 1, wherein the separator used is a separator having a direct drive with flat belt wherein drive spindle and distributor are fashioned as a single component.

7. A developing machine for making printing plates, in particular offset printing plates, having at least one vessel with liquid developer, wherein the vessel is connected to a centrifuge, in particular a separator, for the separation of contaminants from the liquid developer.

8. The apparatus of claim 1, wherein the liquid discharge of the separator is connected to the vessel in order to convey conditioned liquid developer back into the vessel.

9. The apparatus of claim 1, wherein the separator is disposed beneath the vessel in a machine frame.

10. The apparatus of claim 1, wherein the separator is provided with replaceable solids collecting containers, in particular plastic containers.

11. The apparatus of claim 1, wherein a liquid flow is generated for the liquid developer in the vessel through the arrangement of inlet (line 8) and outlet (line 2).

12. The apparatus of claim 1, wherein a prescreen is connected upstream of the separator.

13. The apparatus of claim 1, wherein the separator is a chamber separator with disk inserts.

14. The apparatus of claim 1, wherein the separator has a direct drive with flat belt.

15. The apparatus of claim 1, wherein drive spindle and distributor of the separator are fashioned as a combined component.

16. The apparatus of claim 1, wherein the separator has a monitoring device for avoiding an uncontrolled overflow of the separator.
